(19) United States
(12) Patent Application Publication
(10) Pub. No.: US 2012/0136559 A1
(43) Pub. Date: May 31, 2012

(54) DEVICE AND SYSTEM FOR IDENTIFYING EMERGENCY VEHICLES AND BROADCASTING THE INFORMATION

(75) Inventor: Leigh M. Rothschild, Sunny Isles Beach, FL (US)

(73) Assignee: REAGAN INVENTIONS, LLC, Sunny Isles Beach, FL (US)

(21) Appl. No.: 13/293,539

(22) Filed: Nov. 10, 2011

Related U.S. Application Data
(60) Provisional application No. 61/417,642, filed on Nov. 29, 2010.

(51) Int. Cl. H04N 7/18; G01C 21/00; G06K 9/00; G08G 1/00

(52) U.S. Cl. 701/117; 701/527; 382/104; 348/148; 348/E07.085

(57) ABSTRACT

A system and method for identifying emergency vehicles and broadcasting their location is provided. The system and method gather and process information and data to identify emergency vehicles such as ambulances, fire trucks, and police cars. Further, the system and method is integrated with a locational information system to determine the exact location of the emergency vehicle. Further, the system and method include auxiliary devices to determine the speed and direction of the vehicle and broadcast the location to other drivers in the area.

This application claims priority on U.S. Provisional Application No. 61/417,642 filed on Nov. 29, 2010.

### BACKGROUND

1. Field

A system and method are provided to identify emergency vehicles and broadcast their location to other users.

2. Description of the Related Art

Video detection systems are well known in the prior art and are used as a non-intrusive method of traffic detection. Video from black-and-white or color cameras is fed into processors that analyze the changing characteristics of the video image as vehicles pass. The cameras are typically mounted on poles or structures above or adjacent to the roadway. Most video detection systems require some initial configuration to “teach” the processor the baseline background image. This usually involves inputting known measurements such as the distance between lane lines or the height of the camera above the roadway. A single video detection processor can detect traffic simultaneously from one to eight cameras, depending on the brand and model. The typical output from a video detection system is lane-by-lane vehicle speeds, counts, and lane occupancy readings. Some systems provide additional outputs.

A traffic enforcement camera system, consisting of a camera and a vehicle-monitoring device, is used to identify vehicles disobeying traffic laws by capturing the vehicle's license plate number. For instance, a traffic enforcement camera may be programmed to detect vehicles traveling above the speed limit. Many such devices use radar to detect a vehicle's speed or electromagnetic loops buried in each lane of the road. Traffic enforcement camera systems also use red light cameras that detect and identify vehicles that disobey a stop sign or red light or make an illegal turn against a red light. Other systems feature cameras that identify vehicles that are illegally using designated bus or high occupancy vehicle lanes, crossing cameras that identify vehicles crossing railways at grade illegally, or double white line cameras that identify vehicles crossing these lines.

Many of the vehicle detection systems utilize telemetry software that allows for the measurement and transmission of data remotely. The data can be transmitted using radio waves, infrared, telephone services or the internet. Locational information is often provided by GPS electronics embedded and integrated into the circuitry. 911 operators can use the systems to locate the nearest emergency vehicle, which speeds dispatching and response time.

In-vehicle systems can use multiple modes of communication: data-radio, cellular, satellite, and 802.11. Of those modes, data-radio is by far the most cost effective and technically superior for most urban environments. The 360VL-M4 in-vehicle unit can support these modes and transparently switch between then based on availability, signal strength, and economics.

Automatic Vehicle Location (AVL) is an advanced method used to track and monitor any remote vehicle equipped with a software unit that receives and transfers signals through GPS satellite. AVL is a combination of Global Positioning System (GPS) and Geographic Information System (GIS) that provides actual geographic real time position of each vehicle. The entire transmission mechanism of AVL setup depends on GPS satellite, a receiver on the vehicle, a radio system and PC based tracking software for dispatch. The radio communication system is generally the same as cellular phone network. The two most common AVL systems are GPS based and Signpost based. The Signpost-based AVL system was used earlier, but with the development of modern satellites, GPS technology is used more now.

This AVL system is now widely used in a variety of market systems that offer excellent communication or a vehicle tracking solution. For instance, police and emergency service vehicles are equipped with AVL systems to alert dispatchers to the exact location of vehicles. Further, delivery services may utilize AVL so that an individual can track the exact location of a package or food order. Public transportation vehicles may also use AVL so passengers can estimate the arrival of a vehicle in transit. One drawback to the AVL system is that it is cost prohibitive. Each of the vehicles to be tracked need a GPS or other locational system that will constantly transmit its location. Further, a receiver is needed to collect and interpret the GPS data and produce a real time location which can lead to time delays. Still further, a user will have to constantly monitor the system for updates on the vehicle's location. Thus, it would be preferable to have a system that can automatically alert a user to the location of a vehicle.

Visual Search Technology has been developed for internet searches. The limitations imposed by a text-only search exist in stark contrast to some of the Internet's most important and advanced features, such as hypertext linking and embedded rich media. An individual searching for a picture on the internet is still required to enter several keywords in hopes of finding the picture. In response to this challenge, research organizations and commercial software companies have developed tools that allow a visual search of images and other forms of digital content. With visual search, Internet users can specify their needs and make selections based on images, rather than text. Digitized images consist of arrays of pixel intensities with no inherent meaning, the image databases that contain them are generally unstructured. Content-Based Information Retrieval (CBIR) is the process of searching for and retrieving images from an unstructured database based on information extracted from the content of those images. When searching a database for visual images, CBIR systems base their retrievals on the content of an image, and not on external tags, such as file name, captions, headings, or keywords attached as meta tags. This focus on content, rather than manually defined external tags, provides CBIR systems with the potential to be qualitatively more effective for image searches than any other type of search.

### SUMMARY

A system and method for identifying emergency vehicles and broadcasting their location is provided. The system and method gather and process information and data to identify emergency vehicles such as ambulances, fire trucks, and police cars. Further, the system and method is integrated with a locational information system to determine the exact location of the emergency vehicle. Further, the system and method include auxiliary devices to determine the speed and direction of the vehicle and broadcast the location to other drivers in the area.

In one aspect of the present invention, a method is provided for identifying and broadcasting the location of emergency service vehicles. The method includes identifying emergency services vehicles traveling on a roadway via at least one sensor mounted on a primary vehicle. In the preferred embodiment, the at least one sensor continuously monitors an area surrounding the primary vehicle and transmits the images to a local processor. In another embodiment, the at least one sensor is equipped with computer processing software designed to identify only emergency service vehicles.

The method further includes transmitting images from the at least one sensor to a local processor stored in the primary vehicle. The local processor is equipped with software designed to search the images from the at least one sensor and identify emergency service vehicles. The local processor identifies the type of emergency service vehicle, the status of the emergency service vehicle, including whether the emergency service vehicle is active (i.e. using flashing lights and sirens) or merely traveling at a normal speed on the roadway, and the direction and speed at which the vehicle is traveling.

Still further, the method includes transmitting the emergency service vehicle type, status, speed and direction, and exact location via a communication module located in the primary vehicle. The communication module may utilize satellite, cellular, wifi, infrared, or any other type of communication now known or known in the future to transmit images from the primary vehicle to a remote server.

The method further includes the step of transmitting the emergency service vehicle data from the remote server to an end user. The end user may include a publish-subscribe model web browser that allows users to access and view emergency service vehicle data. The end user may also include vehicles equipped for receiving emergency service vehicle data. In the latter case, the vehicle utilizes the onboard local processor to receive data from the remote processor and alert the vehicle driver of nearby emergency service vehicles.

The invention also relates to a system for identifying emergency vehicles and broadcasting the vehicle's location. The system includes at least one camera or other type of imaging device including digital infrared imaging, mounted on a primary vehicle. The system further includes a display device mounted inside the primary vehicle for displaying video image data from the at least one camera. Still further, the system includes a locational system such as Global Positioning System (GPS) navigation device or any other type of locational system now known or hereinafter known mounted in the primary vehicle. A local computer processor is provided in the primary vehicle to process the output from the cameras and locational data from the GPS system. The computer processor further includes identification and tracking software that utilizes visual search technology or other image identification technology now known or known in the future to search the video and/or images captured by the at least one camera for the purposes of resolving and identifying the emergency vehicles. Still further, the system may include auxiliary devices such as an accelerometer and gyroscope to record the speed and direction of the emergency vehicle being tracked. System may be integrated with the users standalone or the vehicle equipped GPS system.

### BRIEF DESCRIPTION OF THE DRAWINGS

The above and other aspects, features, and advantages of the disclosure will become more apparent in the light of the following detailed description when taken in conjunction with the accompanying drawings in which:

FIG. 1 is a schematic illustration of a system for identifying emergency vehicles and broadcasting their location.

FIG. 2 is a flow chart illustrating a method for identifying emergency vehicles and broadcasting their location.

FIG. 3 is a plan view of a primary vehicle and emergency service vehicle.

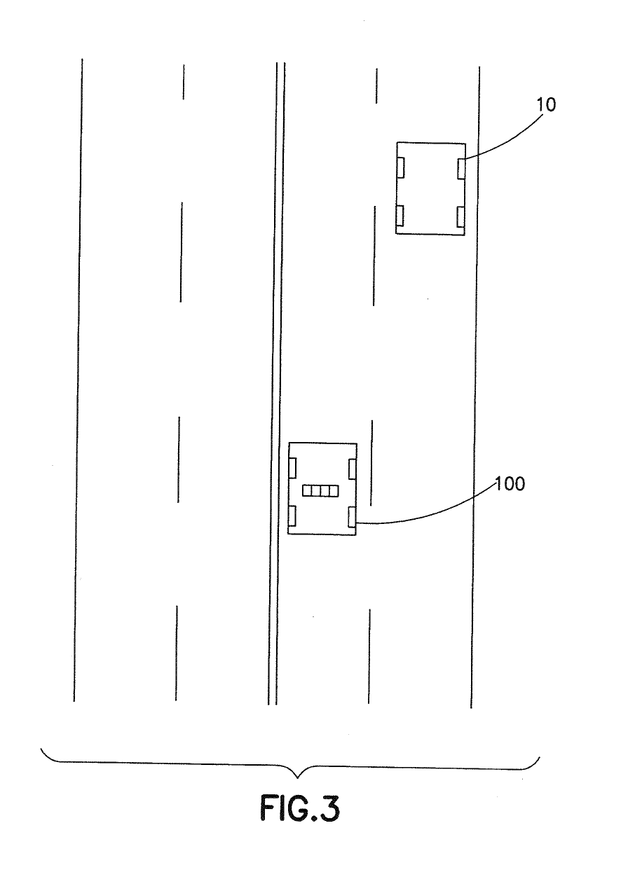

### DETAILED DESCRIPTION

Preferred embodiments of the disclosure will be described herein with reference to the accompanying drawings. In the following description, well-known functions or constructions are not described in detail to avoid obscuring the disclosure.

Embodiments of the present disclosure overcome the shortcomings of existing practices and provides a device and system for identifying emergency vehicles and broadcasting their location.

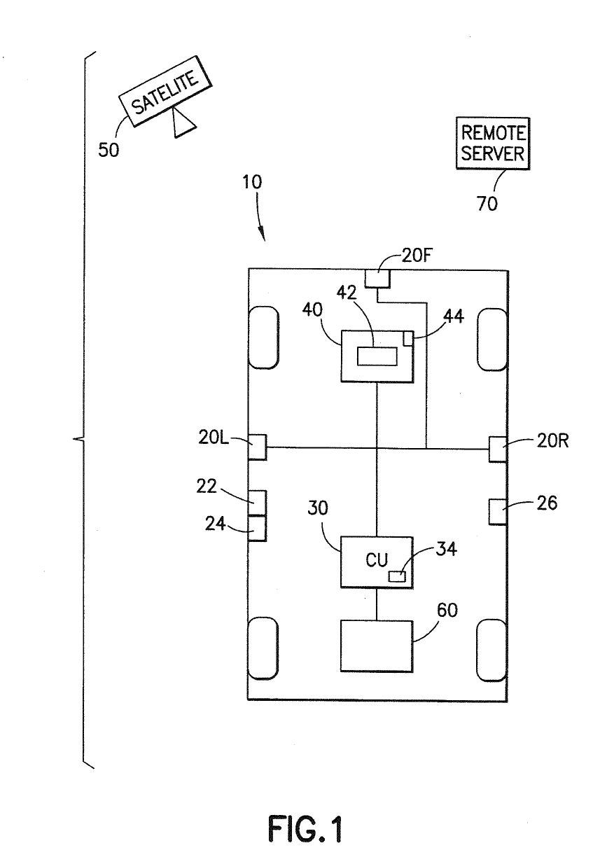

Referring to FIG. 1, a system for identifying emergency vehicles and broadcasting their location is provided. The system includes a primary vehicle 10 equipped with at least one sensor 20 connected to a computer processor 30, e.g., a microprocessor, central processing unit, etc., both of which are configured to identify and capture images of nearby vehicles. The computer processor 30 is configured to analyze images from the at least one sensor 20 to determine whether the nearby vehicles are emergency service vehicles, such as ambulances, police cars, and fire trucks.

The computer processor 30 will use computer software instructions that have been programmed into the computer processor 30 and conventional computer processing power to interact and organize the traffic flow between the various other modules, sensors, etc. of the vehicle. It is to be understood that the present disclosure may be implemented in various forms of hardware, software, firmware, special purpose processors, or a combination thereof. A system bus 32 couples the various components shown in FIG. 1 and may be any of several types of bus structures including a memory bus or memory controller, a peripheral bus, and a local bus using any of a variety of bus architectures. The device also includes an operating system and micro instruction code preferably residing in read only memory (ROM). The various processes and functions described herein may either be part of the micro instruction code or part of an application program (or a combination thereof) which is executed via the operating system.

It is to be further understood that because some of the constituent device components and method steps depicted in the accompanying figures may be implemented in software, the actual connections between the device components (or the process steps) may differ depending upon the manner in which the present disclosure is programmed. Given the teachings of the present disclosure provided herein, one of ordinary skill in the related art will be able to contemplate these and similar implementations or configurations of the present disclosure.

In the preferred embodiment, the at least one sensor 20 comprises cameras mounted on an exterior surface of the vehicle. For instance, in the preferred embodiment, the at least one sensor 20 comprise left side cameras 20L mounted on a left side of the vehicle 10 and right side cameras 20R mounted on the right side of the vehicle 10. The side cameras 20L, 20R are positioned to provide images of nearby vehicles traveling in the same direction as the vehicle 10 and in opposite directions. Additionally, in the preferred embodiment, a front camera 20F is mounted at a forward position of the vehicle 10. The present disclosure should not be limited to this embodiment. The sensors can also consist of a radar systems, night vision cameras, lasers systems, auto focus or auto zoom cameras, electro-magnetic sensors or other known devices capable of providing images of nearby vehicles to the computer processor 30.

Frame grabbers are used to acquire images. The side cameras 20L, 20R, 20F are arranged to capture an image at assigned distance intervals. For instance, the cameras 20L, 20R, 20F may be set to capture one image for every one meter the vehicle 10 travels. The side cameras 20L, 20R are synchronized so that there is some duplication within the images. For instance, in the preferred embodiment, approximately sixty percent of the images captured by the left cameras 20L will be duplicative. The duplication of areas of the images allows the computer processor 30 to monitor the continuity of the nearby vehicles and determine whether they have exited the roadway or switched lanes. In the preferred embodiment, the left and right side cameras 20L, 20R are arranged to face behind the vehicle and capture images of nearby vehicles traveling behind the primary vehicle 10. This overall system may be integrated with a standalone gps system or the vehicles integrated gps system.

A locational information device 40, such as a Global Positioning System (GPS), also is provided. The GPS 40 is connected to a communication network, such as a satellite relay or wireless network 50, to determine the exact position of the vehicle 10 within a network of roads. The GPS 40 has a display screen 42 visible to the operator of the vehicle 10 displaying the vehicle's 10 position on the network of roads. The display screen 42 is also configured to provide messages. The GPS 40 further has a user interface, such as a touch screen, to allow the vehicle operator to enter a driving destination. In one embodiment, the GPS 40 has a speaker 44 to audibly warn the driver of emergency vehicles 100. The GPS 40 also constantly transmits the vehicle 10 location to the satellite relay or wireless network 50.

The computer processor 30 collects and synchronizes information from the at least one sensor 20 and the GPS 40. The computer processor 30 extracts information from the GPS 40 relating to the exact position of the vehicle 10 within the network of roads. The computer processor 30 also obtains information relating to the vehicle's 10 speed and the distance until a driving maneuver is required.

The at least one sensor 20 provides the computer processor 30 with continuous data. Specifically, the at least one sensor 20 provide images of vehicles traveling near the primary vehicle 10. The computer processor 30 includes identification and tracking software that utilizes visual search technology or other image identification technology now known or known in the future to search the video and/or images captured by the at least one camera for the purposes of resolving and identifying emergency vehicles 100. The computer processor 30 determines the type of emergency vehicle 100, the status of the emergency vehicle 100, including whether the emergency vehicle 100 is active (i.e. using flashing lights and sirens) or merely traveling at a normal speed on the roadway, and the direction and speed at which the emergency vehicle 100 is traveling.

The computer processor 30 transmits the location, speed, and direction of active emergency vehicles 100 via a communication module 60 located in the primary vehicle. The communication module 60 may utilize satellite, cellular, wifi, infrared, or any other type of communication now known or known in the future to transmit images from the primary vehicle to a remote server 70. The remote server 70 transmits the location, speed, and direction of the emergency vehicle 100 to end users via a publish-subscribe model web browser that allows users to access and view emergency service vehicle data. Alternatively, the end users may be comprised of vehicles 10 equipped receiving emergency service vehicle data. In the latter case, the computer processor 30 of the presently described system includes a receiving component 34 for receiving information relating to emergency vehicles 100.

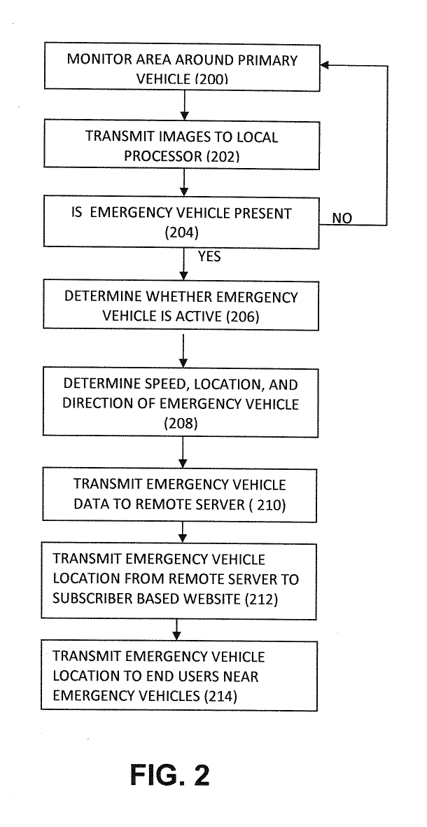

With reference to FIG. 2 a method of the present invention will now be disclosed. The at least one sensor 20 scans and monitors an area around the primary vehicle 10 (step 200). The at least one sensor 20 continuously transmits images to the computer processor 30 (step 202). The computer processor 30 analyzes the images and determines if an emergency vehicle 100 is present in the vicinity of the primary vehicle 10 (step 204). If the computer processor 30 determines that the emergency vehicle 100 is present, then the computer processor determines if the emergency vehicle 100 is active (step 206). The computer processor 30 analyzes the images to determine if the emergency vehicle 100 has lights flashing. Additionally, the at least one sensor 20 may be equipped with a microphone 26 configured to recognize emergency vehicle 100 sirens.

If the emergency vehicle 100 is active, the computer processor 30 determines the location, speed, and direction of travel of the emergency vehicle 100 (step 208). The computer processor 30 determines the location of the emergency vehicle 100 through the GPS 40 and the speed and direction through the accelerator 22 and the gyroscope 24. The computer processor 30 then transmits the emergency vehicle 100 information to a remote server 70 (step 210). The remote server 70 transmits the emergency vehicle 100 location to end users (step 212). The remote server 70 may post the emergency vehicle 100 information to a website for end users. Alternatively, the remote server 70 may determine whether the emergency vehicle 100 is near or traveling towards subscribing end users. The remote server 70 may then selectively alert end users of their proximity to the emergency vehicle 100 (step 214). The method will repeat while the primary vehicle 10 is in use. The information may be integrated with traffic reports that are provided on GPS devices.

Examples of applications of the invention follow. A driver is driving in the primary vehicle 10 and utilizing the GPS device 40. The GPS device 400 alerts the driver that 300 feet behind the driver in the same lane as the driver is an emergency vehicle 100 that is heading towards the primary vehicle 10 at a speed of 60 mph. The driver then yields to the emergency vehicle 100.

A driver is driving in his primary vehicle 10 in Kansas City and is utilizing a GPS device 40 with a display containing a geo mapset of the driver's location. The device produces an audible and visual signal to alert the primary driver that a police vehicle from the Missouri State Troopers Department is 150 feet ahead of the primary vehicle 10. The driver checks his speed of travel and adjusts his speed (if necessary) to make sure he is in conformance with the speed limit.

A driver is in his primary vehicle 10 and receives an alert on a display device in the vehicle 10 that at a certain longitude and latitude ahead on the roadway surface four police cars and one ambulance are present. The driver detours to an alternate route to avoid the emergency vehicles 100.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for identifying and broadcasting the location of emergency vehicles, the method comprising:
monitoring an area near a primary vehicle with at least one sensor to develop images;
transmitting the images to a computer processor;
analyzing the images with the computer processor to determine if an emergency vehicle is present;
determining the location of the emergency vehicle; and
transmitting the location of the emergency vehicle to end users.

2. The method of claim 1, further comprising determining whether the emergency vehicle is utilizing flashing lights or sirens.

3. The method of claim 1, further comprising determining a speed and direction at which the emergency vehicle is traveling.

4. The method of claim 1, wherein the step of transmitting the location of the emergency vehicle further comprises transmitting a speed and direction of the emergency vehicle.

5. The method of claim 1, wherein the step of transmitting the location of the emergency vehicle to end users further comprises transmitting the location to a subscriber-based website for end users to monitor.

6. The method of claim 1, wherein the step of transmitting the location of the emergency vehicle to end users further comprises transmitting the location to devices disposed in the end users' vehicles.

7. The method of claim 6, wherein the location of emergency service vehicles is transmitted to a locational information system disposed in the end users' vehicles.

8. The method of claim 1, further comprising determining the location of the end users in relation to the emergency vehicle and selectively issuing warnings to vehicles near the emergency vehicle.

9. The method of claim 6, wherein the step of issuing warnings to vehicles near the emergency vehicle comprises issuing audible instructions.

10. The method of claim 1, further comprising the step of transmitting traffic reports to end users concurrently with emergency vehicle location information.

11. A system for identifying and broadcasting the location of emergency vehicles, comprising:
at least one sensor for capturing images of vehicles;
a locational information system for determining a location of the vehicles;
a computer processor in communication with the at least one sensor and the locational information system, and configured for identifying the emergency vehicles and a location thereof; and
a communication module for receiving information from the computer processor relating to the emergency vehicles and transmitting said information to end users.

12. The system for identifying and broadcasting the location of emergency vehicles of claim 11, wherein the at least one sensor comprises at least one onboard camera.

13. The system for identifying and broadcasting the location of emergency vehicles of claim 12, further comprising a display device mounted inside the primary vehicle for displaying video image data from the at least one camera and the location of emergency vehicles.

14. The system for identifying and broadcasting the location of emergency vehicles of claim 13, wherein the display device comprises a speaker for audibly warning the driver of emergency vehicles.

15. The system for identifying and broadcasting the location of emergency vehicles of claim 11, wherein the at least one sensor further comprises an accelerometer and gyroscope for measuring the speed and direction of the emergency vehicle.

16. The system for identifying and broadcasting the location of emergency vehicles of claim 11, wherein the at least one sensor is a digital infrared imaging sensor.

17. The system for identifying and broadcasting the location of emergency vehicles of claim 11, wherein the at least one sensor comprises a microphone for gathering noises near the primary vehicle.

18. The system for identifying and broadcasting the location of emergency vehicles of claim 11, wherein the computer processor is configured to identify emergency vehicles using emergency lights and sirens.

19. The system for identifying and broadcasting the location of emergency vehicles of claim 11, wherein the locational information system is programmable to issue turn-by-turn driving instructions along a driving route based on an inputted destination and the locational information system displays the location of emergency vehicles along said driving route.

20. A system for identifying and broadcasting the location of emergency vehicles, comprising:
a primary vehicle including:
at least one sensor for capturing images of other vehicles;
a locational information system for determining a location of the primary vehicle;
a display device mounted in the primary vehicle;
a computer processor in communication with the at least one sensor, the locational information system, and the display device and being operative for identifying emergency vehicles, determining if the emergency vehicles are utilizing emergency lights and sirens, the speed of the emergency vehicle, and the location of the emergency vehicle; and
a communication module for receiving information from the computer processor relating to the emergency vehicles, and displaying said information on the display device.
